(19) United States
(12) Patent Application Publication
(10) Pub. No.: US 2017/0290359 A1
(43) Pub. Date: Oct. 12, 2017

(54) CRYOGENIC FOOD PREPARATION SYSTEM

(71) Applicants: Ilan Nachman, Shimshit (IL); Victor Segal, Kibbutz Reshafim (IL); Boris Barak, Nazareth Ilit (IL)

(72) Inventors: Ilan Nachman, Shimshit (IL); Victor Segal, Kibbutz Reshafim (IL); Boris Barak, Nazareth Ilit (IL)

(21) Appl. No.: 15/096,357

(22) Filed: Apr. 12, 2016

(51) Int. Cl. A23L 3/36; F25B 9/00; F25D 31/00; F25B 9/14

(52) U.S. Cl. CPC A23L 3/363; F25B 9/14; F25B 9/145; F25B 9/00; F25D 31/001; A23V 2002/00; F25B 2309/1402

(57) ABSTRACT

A food preparation system includes a plate including a food preparation surface for placing food thereon. A cryogenerator is in thermal connection with the food preparation surface and can cool the food preparation surface to a temperature below 230 K.

### FIELD OF THE INVENTION

The present invention generally relates to the culinary arts and modern cuisine, and particularly to food preparation with a cryogenic plate.

### BACKGROUND OF THE INVENTION

Modern cuisine encompasses many advanced techniques for food preparation. One of these techniques is flash freezing food, in which food is frozen almost immediately, typically by immersing the food in liquid nitrogen (which has a low boiling point temperature of about −196° C. which is about 77 K; nitrogen melts at 63.2 K). This allows the water inside fruits, vegetables and other foods to freeze without creating large crystals or damaging the cell membranes, thus preserving the texture of frozen foods (which would otherwise be mushy when defrosted). Because liquid nitrogen viscosity is about one-fifth that of water and it has relatively low surface tension, liquid nitrogen flows rapidly into nooks and crannies in foods, such as hamburger patties, that have rough or irregular surfaces. Meat can be first slow-cooked to medium rare, then dunked briefly in liquid nitrogen to freeze a thin layer of the exterior and, finally, deep-fried. The deep-frying creates a brown crust and thaws the frozen layer but does not overcook the interior.

The company POLYSCIENCE manufactures a plate called the ANTI-GRIDDLE, which is a cooling plate maintained at −34.4° C. (238.8 K) that allows rapid unidirectional freezing. The system uses a refrigerant to generate the low temperature. However, the system draws a lot of current (rated at 120 V, 60 Hz, 6.5 A/240 V, 50 Hz, 3.5 A) and is very heavy (weighs over 31 kg).

### SUMMARY OF THE INVENTION

The present invention seeks to provide an improved cryogenic plate for food preparation, as is described more in detail hereinbelow. The system of the present invention is much lighter and compact than the prior art and uses much less electric energy.

There is thus provided in accordance with an embodiment of the present invention a food preparation system including a plate including a food preparation surface for placing food thereon, and a cryogenerator in thermal connection with the food preparation surface and operative to cool the food preparation surface to a temperature below 230 K.

In accordance with an embodiment of the present invention the cryogenerator may be an external heat engine or a closed-cycle thermal device.

In accordance with an embodiment of the present invention the cryogenerator operates on a Stirling cycle, such as a Stirling engine or a thermoacoustic engine. The cryogenerator may further include a regenerator.

In accordance with an embodiment of the present invention the cryogenerator moves a working fluid through passages thermally connected to the food preparation surface.

In accordance with an embodiment of the present invention the cryogenerator is operative to cool the food preparation surface to a temperature below 200K, or below 100 K or even below 70 K.

### BRIEF DESCRIPTION OF THE DRAWINGS

The present invention will be understood and appreciated more fully from the following detailed description taken in conjunction with the drawing in which:

FIG. 1 is a simplified illustration of a food preparation system, in accordance with a non-limiting embodiment of the present invention.

### DETAILED DESCRIPTION OF EMBODIMENTS

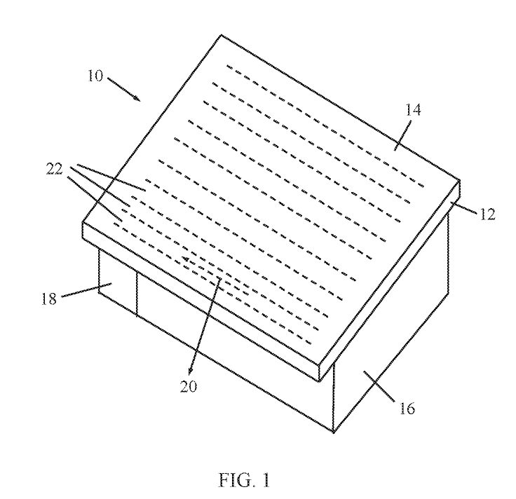

Reference is now made to FIG. 1, which illustrates a food preparation system 10, in accordance with a non-limiting embodiment of the present invention.

The food preparation system 10 includes a plate 12, which has a food preparation surface 14 for placing food thereon. The food preparation surface 14 may be made of metal (e.g., stainless steel) or of a material with a poor thermal conductivity (e.g., plastic). A cryogenerator 16 is in thermal connection with the food preparation surface 14 and can cool the food preparation surface 14 to a temperature below 230 K, or below 200 K, or below 100 K, and even below 70 K.

In accordance with an embodiment of the present invention cryogenerator 16 may be an external heat engine or a closed-cycle thermal device. For example, cryogenerator 16 may operate on a Stirling cycle, such as a Stirling engine or a thermoacoustic engine. Cryogenerator 16 may further include a regenerator 18.

For example, the Stirling engine may typically include a piston, a compression space, an ambient heat exchanger, a regenerator, a low temperature heat exchanger, an expansion space, and a piston. Without limitation, a Stirling engine which may be used to carry out the invention is the dual-opposed, twin piston, linear Stirling Cryocooler K535, manufactured by Ricor of Ein-Harod Israel. This Stirling engine only weighs 9.5 kg and uses just 7 W of power to reach 65 K at an ambient of 23° C., all of which are significant improvements over the prior art.

In accordance with an embodiment of the present invention cryogenerator 16 moves a working fluid 20 (e.g., helium) through passages 22 thermally connected to the food preparation surface 14 (such as channels formed through plate 12 or pipes attached to the bottom of plate 12). The working fluid 20 is permanently contained within the system.

What is claimed is:

1. A food preparation system comprising:
a plate comprising a food preparation surface for placing food thereon; and
a cryogenerator in thermal connection with said food preparation surface and operative to cool said food preparation surface to a temperature below 230 K.

2. The food preparation system according to claim 1, wherein said cryogenerator comprises an external heat engine.

3. The food preparation system according to claim 1, wherein said cryogenerator comprises a closed-cycle thermal device.

4. The food preparation system according to claim 1, wherein said cryogenerator comprises a Stirling engine.

5. The food preparation system according to claim 1, wherein said cryogenerator comprises a regenerator.

6. The food preparation system according to claim 1, wherein said cryogenerator operates on a Stirling cycle.

7. The food preparation system according to claim 1, wherein said cryogenerator comprises a thermoacoustic engine.

8. The food preparation system according to claim 1, wherein said cryogenerator moves a working fluid through passages thermally connected to said food preparation surface.

9. The food preparation system according to claim 1, wherein said cryogenerator is operative to cool said food preparation surface to a temperature below 200 K.

10. The food preparation system according to claim 1, wherein said cryogenerator is operative to cool said food preparation surface to a temperature below 100 K.
